(19) United States
(12) Patent Application Publication
(10) Pub. No.: US 2026/0180016 A1
(43) Pub. Date: Jun. 25, 2026

(54) FORMATION APPARATUS AND METHOD FOR FORMING POSITIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Isehara, Kanagawa (JP)

(21) Appl. No.: 19/127,258

(22) PCT Filed: Nov. 7, 2023
(86) PCT No.: PCT/IB2023/061206

§ 371 Date: May 5, 2025

(30) Foreign Application Priority Data
Nov. 14, 2022 (JP) 2022-181968

(51) Int. Cl. H01M 10/0525; H01M 4/131

(52) U.S. Cl. CPC H01M 10/0525; H01M 4/131

(57) ABSTRACT

An object is to provide a method for forming a positive electrode active material with low production cost. Another object is to provide a formation apparatus capable of forming a positive electrode active material with low production cost. In the method for forming the positive electrode active material, it is preferable that a material to be heated be heated in an atmosphere containing fluoride, i.e., the material to be heated be heated in a state where a partial pressure of a fluoride gas in a heating furnace is high. The fluoride gas is supplied to the heating furnace and circulated. Furthermore, the material to be heated is stirred during heating.

### TECHNICAL FIELD

The present invention relates to a formation apparatus for an oxide that can be used for a positive electrode active material. Also, the present invention relates to a method for forming a positive electrode active material.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

As the demand has grown, the productivity of lithium-ion batteries and their materials are required to be improved. As part of the improvement, an effective method for forming a positive electrode active material, which is a material of a lithium ion battery, has been developed. For example, Patent Document 1 discloses a method for forming a positive electrode active material with use of a rotary kiln capable of successive processing.

Fluorides such as fluorite (calcium fluoride) have been used as fusing agents in iron manufacture and the like for a very long time, and the physical properties of fluorides have been studied (Non-Patent Document 1).

### REFERENCES

### Patent Document

[Patent Document 1] PCT International Publication No. WO2021/116819 Pamphlet

### Non-Patent Document

[Non-Patent Document 1] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36[1] 12-17 (1953).

### SUMMARY OF THE INVENTION

### Problems to be Solved by the Invention

A positive electrode active material is a high-cost material among lithium-ion secondary batteries, and improvement in its productivity is highly effective. At the same time, the demand for improvement in performance (e.g., increase in capacity, cycle performance, reliability, or safety) is also high.

In view of the above, an object of one embodiment of the present invention is to provide a method for forming a positive electrode active material with low production cost. Another object is to provide a formation apparatus capable of forming a positive electrode active material with low production cost. Another object is to provide a method for forming a positive electrode active material whose crystal structure is not easily broken even when charging and discharging are repeated. Another object is to provide a method for forming a positive electrode active material with excellent charge and discharge cycle performance. Another object is to provide a method for forming a positive electrode active material with high charge and discharge capacity. Another object is to provide a highly reliable or safe secondary battery.

Note that the description of these objects does not preclude the existence of other objects. One embodiment of the present invention does not necessarily achieve all these objects. Other objects can be derived from the description of the specification, the drawings, and the claims.

### Means for Solving the Problems

An example of a method for forming LiMO₂ (Mis one or more kinds of metals including Co, and substitution positions of the metals are not particularly limited), which is an oxide including lithium and used as a positive electrode active material, is described in one embodiment of the present invention.

In a formation method of one embodiment of the present invention, part of a material to be heated, e.g., LiF, which is a fluorine source, functions as a fusing agent in some cases. Owing to this function, a heating temperature can be lowered to a temperature lower than a decomposition temperature of lithium cobalt oxide, e.g., higher than or equal to 742° C. and lower than or equal to 950° C., which allows distribution of an additive element such as magnesium in a surface portion and formation of a positive electrode active material having excellent characteristics. For example, when the additive element such as magnesium exists in the surface portion, an excessive reaction between the positive electrode active material and an electrolyte solution in charge and discharge cycles can be inhibited. Alternatively, release of oxygen from the positive electrode active material can be inhibited.

However, since LiF in a gas phase has a specific gravity less than that of oxygen, heating might volatilize LiF and in that case, LiF in the material to be heated decreases. As a result, the function of a fusing agent deteriorates. Therefore, heating needs to be performed while volatilization of LiF is inhibited. Note that even when LiF is not used as the fluorine source or the like, Li at a surface of LiMO₂ and F of the fluorine source might react to produce LiF, which might be volatilized. Thus, such inhibition of volatilization is needed also when a fluoride having a higher melting point than LiF is used.

In view of this, the material to be heated is preferably heated in an atmosphere containing fluoride, i.e., the material to be heated is preferably heated in a state where a partial pressure of a fluoride gas in a heating furnace is high. The fluoride gas is supplied into the heating furnace and circulated by a circulation unit. As a gas circulation unit, a gas supply device or a gas exhaust device may be provided with a circulation unit; for example, a gas circulation device that generates a gas by means of sublimating lithium fluoride by heating may be used. In order to circulate the fluoride gas, a pipe or a heating furnace may be provided with an air-blowing mechanism (a fan) or the like as a circulation unit or a gas stirring unit, and the atmosphere around a heat-resistant container is stirred by circulation. Note that when circulation is performed, the space including the pipe for circulation is hermetically sealed, so that an outside air is prevented from entering. By such heat treatment in the atmosphere containing fluoride, volatilization of LiF from the material to be heated can be inhibited.

In this specification, an atmosphere containing fluoride refers to an atmosphere of a mixed gas containing fluoride as at least one of constituting components or an atmosphere under a condition of the mixed gas.

Adhesion of particles of the material to be heated during heating might decrease an area of contact with oxygen in the atmosphere and inhibit a path of diffusion of the additive element, thereby hindering distribution of the additive element (e.g., magnesium) in the surface portion of the positive electrode active material. Therefore, stirring is preferably performed during heating so that the particles of the material to be heated do not adhere to one another. When stirring is performed to prevent the adhesion, the material to be heated can be processed successively and a large amount of material to be heated can be processed in a short time.

In order to stir the material to be heated during heating, a rotary kiln including a rotating drum or a cylindrical furnace tube is preferably used, in which case adhesion between particles can be inhibited. It is preferable that the fluoride gas introduced into the kiln be released to an outside of the kiln through the pipe and then circulated and introduced again into the kiln so as to control the atmosphere inside the kiln. A heating time is longer than or equal to 10 hours in some cases; when a gas is continuously supplied from a cylinder during the heating time, an enormous amount of gas is required and a load on a detoxification device that detoxicates an exhausted gas is large. When a new gas is constantly supplied from the cylinder, a temperature of the atmosphere might be changed depending on a gas flow rate or a gas temperature. Thus, circulation leads to a reduction in production cost and an increase in productivity.

One embodiment of the present invention is a method for forming a positive electrode active material including a crystal containing lithium, a transition metal, and oxygen, the method including a step of inhibiting adhesion during heating of a material to be heated in an atmosphere where introduction of a fluoride gas containing a fluorine atom in a chemical structure is controlled. The transition metal can be one or two or more selected from cobalt, nickel, and manganese.

Specifically, heat treatment is performed while the material to be heated is stirred in an atmosphere where a gas containing fluorine and oxygen is circulated, so that crystallinity of the crystal included in the material to be heated is improved.

A formation apparatus to achieve the method for forming a positive electrode active material is also one embodiment of the present invention. The formation apparatus is structured to heat a heating chamber while a material to be heated is stirred in an atmosphere where a gas containing a fluoride gas and an oxygen gas is circulated.

In the above structure, in the atmosphere where the gas containing the fluoride gas and the oxygen gas is circulated, the fluoride gas and the oxygen gas are circulated in the heating chamber, whereby an amount of the gas used and formation cost can be reduced.

Specifically, in the case of a batch formation apparatus, a material is heated while the fluoride gas and the oxygen gas are supplied into a rotating furnace.

One embodiment of the present invention is a formation apparatus including a heating furnace including a sealed atmosphere, a heat-resistant container that is placed in the atmosphere, stores a material to be heated inside, and stirs the material to be heated during heating, a supply unit supplying a gas including a fluoride gas and an oxygen gas to the heating furnace, an exhaust unit exhausting the gas in the heating furnace, and a supply pipe supplying the gas exhausted from the exhaust unit to the heating furnace from the supply unit again.

The formation apparatus is not limited to the batch formation apparatus and may be a formation apparatus in which a material is heated while the fluoride gas and the oxygen gas are supplied; for example, the formation apparatus controls the atmosphere while the fluoride gas and the oxygen gas are supplied when heat treatment is performed in a state where the material to be heated is contained in a cylindrical heat-resistant container with a lid.

The formation apparatus may be employed in which a material is stored in a sealed cylindrical heat-resistant container and a plurality of the heat-resistant containers are heated in an oxygen gas atmosphere containing a fluoride gas while being successively moved in a cylindrical furnace tube having a diameter larger than a diameter of the heat-resistant container.

Specifically, the heating furnace includes a furnace tube, the furnace tube is cylindrical and controlled to rotate with the plurality of heat-resistant containers put therein. It is preferable that an axis direction of the furnace tube be provided to be inclined from a horizontal direction so that the heat-resistant container can move easily in the furnace tube. Furthermore, the heat-resistant container may be moved in the furnace tube using a transfer robot.

The heat-resistant container (also referred to as a capsule or a pod) is preferably a ceramic material with high heat resistance. An outside wall of the heat-resistant container may have a structure with a projection to guide movement of the container in the cylindrical furnace tube. Without limitation to a dedicated ceramic container, the projection may be provided such that an attachment is attached to part of a commercial ceramic container (cylindrical container). A mechanism may be employed in which the container is automatically moved in the axis direction of the furnace tube simply by rotating the furnace tube with the use of the projection of the container.

When the gas containing the fluoride gas and the oxygen gas is supplied into the heating furnace, the gas may be converted to plasma and supplied as a gas containing a reactive active species. In the case of employing a remote method, the gas containing the reactive active species may be introduced into the furnace with the use of a plasma apparatus including a remote plasma module.

### Effect of the Invention

According to one embodiment of the present invention, a method for forming a positive electrode active material with low production cost can be provided. According to one embodiment of the present invention, heat treatment is performed while a material to be heated is stirred in an atmosphere where a gas containing a fluoride gas and an oxygen gas is circulated, so that crystallinity of a crystal contained in the material to be heated can be improved. By improving the crystallinity of the crystal contained in the material to be heated, a secondary battery using the material heated as a positive electrode active material has high discharge capacity and favorable cycle performance, and thus can be used for a long time over a long period.

Furthermore, according to one embodiment of the present invention, an atmosphere where a gas is circulated is employed; thus, a novel formation apparatus that can form a positive electrode active material with low production cost can be provided.

### BRIEF DESCRIPTION OF THE DRAWINGS

FIG. 1A is an example of a schematic cross-sectional view of a formation apparatus of one embodiment of the present invention, and FIG. 1B is a schematic cross-sectional view illustrating an example of a cross section of a furnace tube.

FIG. 2 is a phase diagram showing a relationship between temperature and compositions of lithium fluoride and magnesium fluoride.

FIG. 3A is an example of a schematic cross-sectional view of a formation apparatus of one embodiment of the present invention, FIG. 3B is a schematic cross-sectional view illustrating an example of a cross section of a furnace tube, and FIG. 3C is a schematic view illustrating a cross section of a heat-resistant container 120.

FIG. 4A and FIG. 4B are diagrams showing an example of a method for forming a positive electrode active material.

FIG. 5 is a diagram showing an example of a method for forming a positive electrode active material.

FIG. 6 is a diagram showing an example of a method for forming a positive electrode active material.

FIG. 7 is a diagram illustrating the appearance of a secondary battery.

FIG. 8A to FIG. 8C are diagrams illustrating a method for forming a secondary battery.

FIG. 9A and FIG. 9B are diagrams each illustrating a structure example of a secondary battery.

FIG. 10A to FIG. 10H are diagrams each illustrating an example of an electronic device.

FIG. 11A to FIG. 11D are diagrams each illustrating an example of an electronic device.

FIG. 12A to FIG. 12C are diagrams each illustrating an example of an electronic device.

FIG. 13A to FIG. 13C are diagrams each illustrating an example of a vehicle.

### MODE FOR CARRYING OUT THE INVENTION

Hereinafter, embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

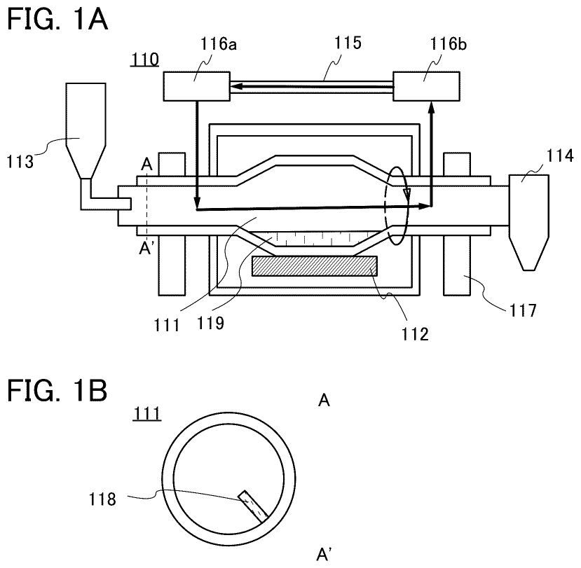

In this embodiment, a formation apparatus of one embodiment of the present invention will be described with reference to FIG. 1. The formation apparatus is suitable for forming a positive electrode active material. Specifically, after lithium cobalt oxide as a composite oxide containing lithium and cobalt is mixed with a mixture, heat treatment is performed while a material to be heated is stirred in an atmosphere where a gas containing a fluoride gas and an oxygen gas is circulated. Note that as the mixture, a mixture of at least lithium fluoride (LiF) and magnesium fluoride (MgF₂) is used.

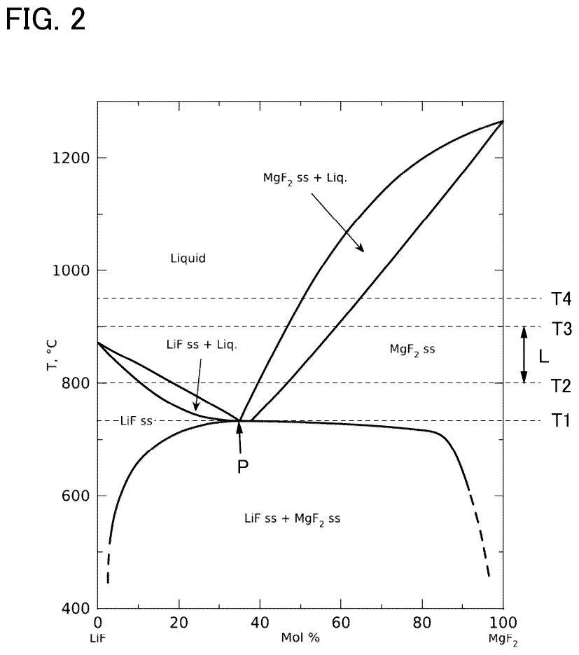

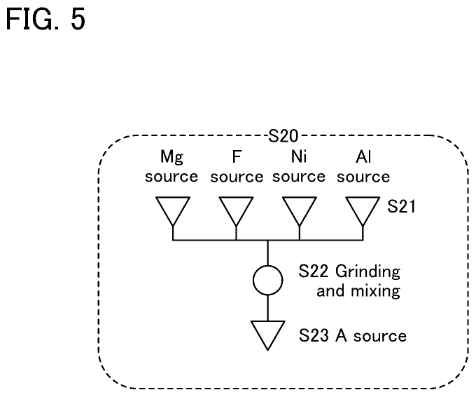

In the case where a fluoride such as lithium fluoride has a lower melting point than the other additive element sources, the fluoride can serve as a fusing agent (also referred to as a flux agent) for lowering the melting points of the other additive element sources. In the case where the fluoride contains LiF and MgF₂, the eutectic point P of LiF and MgF₂ is around 742° C. (T1) as shown in FIG. 2 (which is cited from FIG. 5 of Non-Patent Document 1 and retouched); thus, the heating temperature in the heat treatment after mixing the additive element is preferably higher than or equal to 742° C.

### <Batch Rotary Kiln>

FIG. 1A is a schematic cross-sectional view of a batch rotary kiln 110. The rotary kiln 110 includes a kiln main body 111, which is a rotating drum, a heating unit 112, a source material supply unit 113, and a material collection unit 114. The rotary kiln 110 includes a rotation driving device 117, a gas supply unit 116a, and a gas exhaust unit 116b. Although not illustrated in the gas exhaust unit 116b, a pump for exhausting a gas inside the kiln main body 111, a valve for preventing the backflow of a gas, a detoxification device (a combustion detoxification device or a plasma detoxification device) for detoxicating a gas before its release to the outside air, or the like may be provided. Since a fluoride gas is used, it is preferable to use pipes including a material that is unlikely to react with a fluoride gas on an inner wall as pipes for supplying a gas, and a plurality of valves may be provided for each of the pipes to prevent gas leakage. It is preferable to use a material that is unlikely to react with a fluoride gas not only for the pipes but also for components used for joint portions, e.g., a joint portion between a pipe and a furnace, a joint portion between a pipe and the gas supply unit 116a, and a joint portion between a pipe and the gas exhaust unit 116b.

The gas supply unit 116a has a function of controlling an atmosphere inside the kiln main body 111 (also referred to as inside a treatment chamber). An example of the gas supply unit 116a is a gas introduction line. Gases to be introduced are preferably oxygen and a fluoride gas (a fluorine (F₂) gas, a sulfur fluoride (SF₆) gas, a carbon fluoride (CF_{X}) gas, a nitrogen fluoride (NF₃) gas, or an oxygen fluoride (OF₂, O₂F₂, O₃F₂, O₄F₂, OsF₂, O₆F₂, or O₂F) gas). In the case where the atmosphere inside the kiln main body 111 is replaced, a desired atmosphere can be obtained by exhausting the gas inside by the gas exhaust unit 116b and then supplying a gas from the gas supply unit 116a.

The source material supply unit 113 and the gas exhaust unit 116b are connected, and a supply pipe 115, which is one of the pipes for circulating a gas, is provided. Since the gas is circulated, a sealed space inside the kiln main body 111 is maintained. In FIG. 1A, the inside of the treatment chamber and the inside of the pipe connected for the gas circulation are a sealed space, in which the gas is circulated. Furthermore, circulating the gas using pipes such as the supply pipe 115 can save the gas to be used.

Although not illustrated in FIG. 1, a first cylinder in which an oxygen gas is stored and a second cylinder in which a fluoride gas is stored are connected to the source material supply unit 113. Each of the cylinders is connected to the source material supply unit 113 through a flow rate meter.

Although a pipe from the gas supply unit 116a is not illustrated in FIG. 1 for simplicity, an arrow indicating the gas flow is illustrated. A pipe from the gas exhaust unit 116b is not illustrated either for simplicity. As illustrated in FIG. 1, arrows indicating a path of the gas flow are illustrated and a state where the gas is circulated while a sealed space is maintained is illustrated.

Since the kiln main body 111 rotates, the pipe from the gas supply unit 116a is preferably connected using a rotary joint or the like. Also, the pipe from the gas exhaust unit 116b is preferably connected using a rotary joint or the like.

The kiln main body 111 illustrated in FIG. 1 has a substantially cylindrical shape that is thick in the middle, the source material supply unit 113 is connected to one end of the kiln main body 111, and the other end of the kiln main body 111 is provided with the material collection unit 114. By rotating, the kiln main body has a function of stirring an object 119 put into the kiln, that is, the material to be heated.

The heating unit 112 has a function of heating the kiln main body 111 to a temperature higher than or equal to 700° C. and lower than or equal to 1200° C. As the heating unit 112, a silicon carbide heater, a carbon heater, a metal heater, or a molybdenum disilicide heater can be used, for example.

The source material supply unit 113 has a function of putting the object 119 into the kiln main body 111. Although there is no particular limitation on the source material supply unit 113, a screw conveyor is used, for example.

The batch rotary kiln 110 may be provided with a variety of measurement devices. A measurement device can measure the atmosphere inside the kiln main body 111, for example. For the measurement device, gas chromatography (GC), a mass spectrometer (MS), GC-MS, infrared spectroscopy (IR), or Fourier transform-infrared spectroscopy (FT-IR) can be employed. By measuring the atmosphere, more specifically partial pressures of lithium fluoride, oxygen, and the like, in the kiln main body 111, whether the heating conditions are preferable can be ascertained. Note that the measurement device may be a measurement device other than the one measuring the state of the atmosphere as long as whether the heating conditions are preferable can be ascertained. For example, as the measurement device, a quartz crystal oscillation type film thickness meter or the like may be provided in the exhaust port or the vicinity thereof. By measuring the thickness of lithium fluoride that is exhausted, cooled down, and deposited with the quartz crystal oscillation type film thickness meter, the lithium fluoride can be measured quantitatively. Note that a plurality of the measurement devices may be provided, or a plurality of kinds of measurement devices may be provided.

Since the rotary kiln 110 can stir the object 119 by rotating the kiln main body 111 during heating, particles of the object 119 are unlikely to adhere to one another. That is, a step of rotating the kiln main body 111 corresponds to an adhesion preventing step.

As illustrated in FIG. 1B, the rotary kiln 110 may include the kiln main body 111 provided with a blade 118 for moving the object 119 into the kiln or stirring the object 119. FIG. 1B is a schematic cross-sectional view of the batch rotary kiln 110, and FIG. 1B is a cross-sectional view of the kiln main body 111 taken along the dotted line A-A′ in FIG. 1A.

Although FIG. 1B illustrates the kiln main body 111 provided with one linear blade 118 as an example, one embodiment of the present invention is not limited thereto. A plurality of blades 118 may be provided. The blade 118 may have another shape such as a helical shape.

### <Sequential Rotary Kiln>

The rotary kiln is not limited to the batch rotary kiln, and a sequential rotary kiln may be employed. In addition, a heat treatment apparatus using a method in which heat treatment is performed in a state where a source material is contained in a cylindrical heat-resistant container with a lid may be employed.

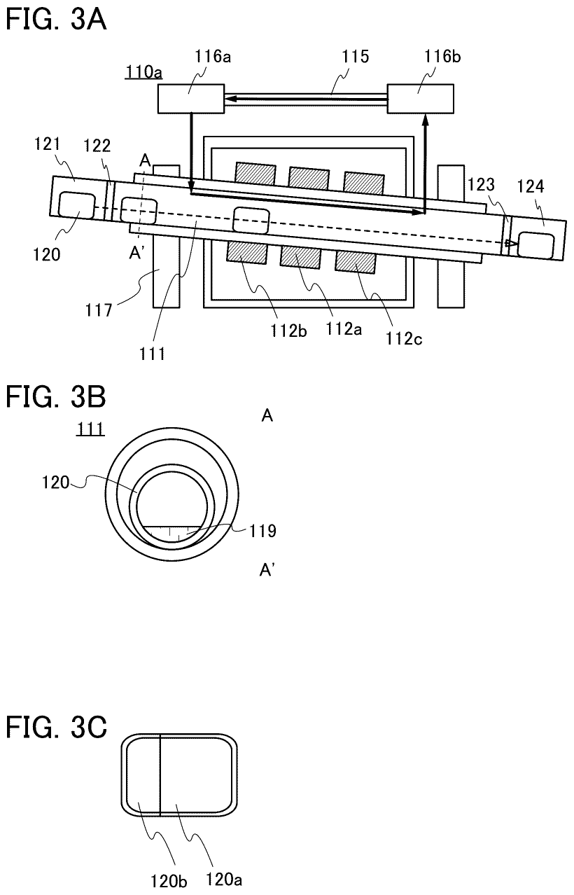

FIG. 3A is a schematic cross-sectional view of a rotary kiln 110a into which a plurality of heat-resistant containers can be put sequentially. Note that the same portions as in FIG. 1A are described below using the same reference numerals.

The rotary kiln 110a includes the kiln main body 111, a heating unit 112a, a heating unit 112b, a heating unit 112c, a load chamber 121, an unload chamber 124, a shutter 122, and a shutter 123. The rotary kiln 110a includes the rotation driving device 117, the gas supply unit 116a, and the gas exhaust unit 116b.

Since the gas exhaust unit 116b, the supply pipe 115, and the gas supply unit 116a may have the same structures as those in FIG. 1A, the same reference numerals are used in FIG. 3A and the detailed description thereof is omitted here.

Also in FIG. 3A, arrows indicating a path of the gas flow are illustrated as the gas is circulated, and a state where the gas is circulated in a closed space is illustrated. In FIG. 3A, the inside of the furnace tube (the inside of the treatment chamber) and the inside of the pipe connected for the gas circulation are a sealed space, in which the gas is circulated.

The shutter 122 and the shutter 123 are provided to maintain the airtightness, and after the shutter 122 is opened and the heat-resistant container 120 put into the load chamber 121 is moved in, the shutter 122 is closed and the heat treatment is performed. Note that the heating unit 112b can be set to a higher temperature than the heating unit 112a and the heating unit 112c to adjust the heating temperature. After the heat treatment, the shutter 123 is opened and the heat-resistant container 160 is moved out to the unload chamber, and then the shutter 123 is closed.

A plurality of heat-resistant containers 120 can be put inside sequentially and heating can be performed successively; thus, the productivity is improved.

The kiln main body 111 has a cylindrical furnace tube in which the plurality of heat-resistant containers 120 are put, and is rotated by the rotation driving device 117. FIG. 3A illustrates a structure in which the axis direction of the furnace tube is provided to be inclined from the horizontal direction so that the heat-resistant containers 120 can move easily in the furnace tube.

Although not illustrated, as for the heat-resistant container 120, one end of the heat-resistant container 120 may be pushed out and moved at a constant speed in the furnace tube using a transfer robot. The movement of the heat-resistant container 120 in the furnace tube is not limited to being set at a constant speed. Alternatively, a structure may be employed in which after the heat-resistant container 120 is moved to a position close to the heating unit, the heat-resistant container 120 is heated at the position while being rotated for stirring, and after the heat treatment is performed sufficiently, the heat-resistant container 120 is pushed out and the heat treatment is terminated.

FIG. 3B is a schematic cross-sectional view of the batch rotary kiln 110a, and FIG. 3B is a cross-sectional view of the kiln main body 111 and the heat-resistant container 120 taken along the dotted line A-A′ in FIG. 3A.

As illustrated in FIG. 3B, the mechanism is such that the object 119 is stored in the heat-resistant container 120 and the cylindrical heat-resistant container 120 rotates as the kiln main body 111 rotates, whereby the object 119 inside is stirred during heating.

The heat-resistant container 120 is preferably a ceramic material with high heat resistance. FIG. 3C illustrates an example of a cross section of the heat-resistant container 120 which can be separated into a main body portion 120a and a lid portion 120b and in which a material to be heated can be stored. Note that the heat-resistant container 120 is not completely sealed even with the lid on and affects the atmosphere therearound. In the rotary kiln 110a, the inside of the heat-resistant container 120 can also be filled with the fluoride gas and the oxygen gas, and the space around the heat-resistant container 120 (around the heat-resistant container in the furnace tube) can also be filled with the fluoride gas and the oxygen gas.

The apparatus structures in FIG. 1A and FIG. 3A are examples and the apparatuses are not particularly limited thereto as long as they can perform heat treatment while a material to be heated is stirred in an atmosphere where a gas containing a fluoride gas and an oxygen gas are circulated. When the heating time is as long as 10 hours or longer, using a circulated gas can reduce cost of producing a positive electrode active material and increase the productivity.

### Embodiment 2

### <<Example 1 of Method for Forming Positive Electrode Active Material>>

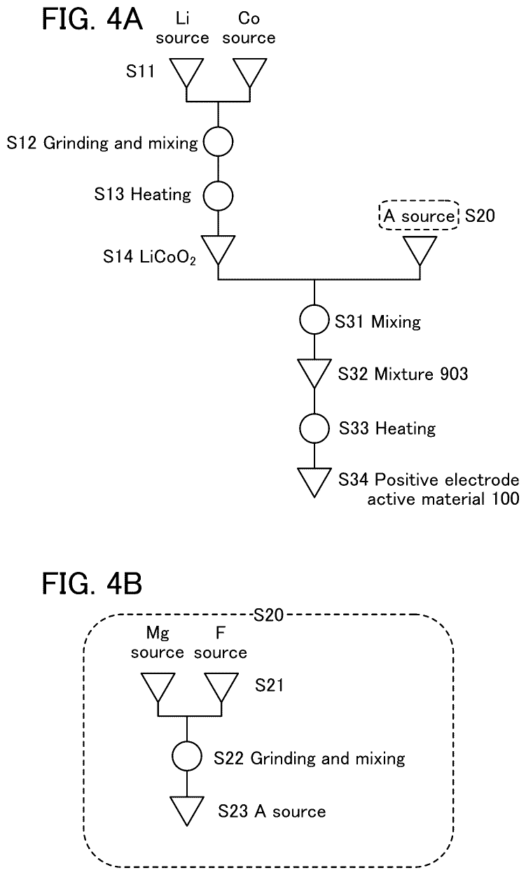

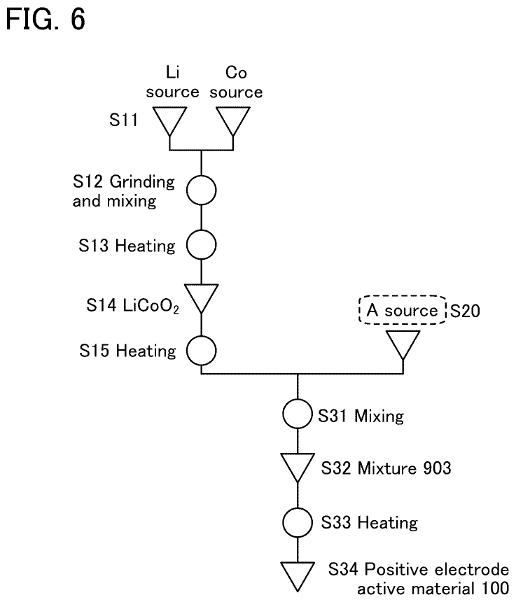

A method for forming a positive electrode active material 100 is described with reference to FIG. 4A, FIG. 4B, FIG. 5, and FIG. 6. Although the method for forming the positive electrode active material 100 described below includes a plurality of steps of mixing and heating a plurality of materials, at least one of the steps is performed using the apparatus illustrated in FIG. 1A or FIG. 3A, and heating in the other steps can be performed using a crucible made of aluminum oxide or a setter (also referred to as a saggar) made of aluminum oxide.

### <Step S11>

In Step S11 shown in FIG. 4A, a lithium source (Li source) and a cobalt source (Co source) are prepared as materials for lithium and cobalt.

As the lithium source, a lithium-containing compound is preferably used and, for example, lithium carbonate, lithium hydroxide, lithium nitrate, or lithium fluoride can be used. The lithium source preferably has a high purity; for example, the purity is preferably higher than or equal to 4N (99.99%). Note that a plurality of kinds of lithium sources may be used.

As the cobalt source, a cobalt-containing compound is preferably used and, for example, cobalt oxide or cobalt hydroxide can be used. Note that a plurality of kinds of cobalt sources may be used. The cobalt source preferably has a high purity; for example, the purity is preferably higher than or equal to 3N (99.9%), further preferably higher than or equal to 4N (99.99%), still further preferably higher than or equal to 4N5 (99.995%), yet still further preferably higher than or equal to 5N (99.999%).

The use of a high-purity material can reduce the amount of impurities in the positive electrode active material. As a result, the capacity of a secondary battery is increased and/or the reliability of the secondary battery is improved.

Furthermore, the cobalt source preferably has high crystallinity and, for example, the cobalt source preferably includes single crystal grains. The crystallinity of the cobalt source can be evaluated with a TEM image, a scanning transmission electron microscope (STEM) image, a high-angle annular dark field scanning transmission electron microscope (HAADF-STEM) image, an annular bright-field scanning transmission electron microscope (ABF-STEM) image, X-ray diffraction (XRD), electron diffraction, or neutron diffraction. A plurality of kinds of methods may be used for evaluating the crystallinity. Note that the above methods for evaluating the crystallinity can also be employed to evaluate the crystallinity of materials other than the cobalt source.

In Step S11, part of an A source described later may be prepared. For example, a nickel source may be prepared as the A source. Nickel is expected to have an effect of inhibiting deterioration of the crystal structure in charge and discharge cycles by existing in the positive electrode active material 100.

As the nickel source, nickel oxide or nickel hydroxide can be used, for example. Note that a plurality of kinds of nickel sources may be used.

### <Step S12>

Next, in Step S12 shown in FIG. 4A, the lithium source and the cobalt source are ground and mixed to form a mixed material. In the case where the nickel source is prepared in Step S11, the nickel source is added to form a mixed material similarly. The grinding and mixing can be performed by a dry method or a wet method. A wet method is preferable because it can crush a material into a smaller size. When a wet method is employed, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is further preferably used. In this embodiment, dehydrated acetone with a purity higher than or equal to 99.5% is used. It is preferable that the lithium source and the cobalt source be mixed into dehydrated acetone whose moisture content is less than or equal to 10 ppm (parts per million) and which has a purity higher than or equal to 99.5% for the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill container is 40 mm).

### <Step S13>

Next, in Step S13 shown in FIG. 4A, the mixed material is subjected to heat treatment.

A temperature rising rate in a temperature rising step of the heat treatment is preferably higher than or equal to 80° C./h and lower than or equal to 250° C./h, although depending on the end-point temperature. In the case where the temperature of the temperature retaining step is 1000° C., for example, the temperature rising rate is preferably 200° C./h.

The temperature rising rate in a treatment chamber of a heat treatment apparatus preferably falls within the above range. Note that the temperature rising rate set for the heat treatment apparatus is not the same as the temperature rising rate in the treatment chamber in some cases. For example, the temperature rising rate in the treatment chamber is sometimes lower than the set temperature rising rate. The set temperature rising rate is adjusted such that the temperature rising rate in the treatment chamber falls within the above range. Note that in the case where the temperature in the treatment chamber cannot be measured, the temperature rising rate is set for the heat treatment apparatus to fall within the above range. In the case where the temperature of an object can be measured, it is further preferable that the temperature rising rate of the object fall within the above range.

The temperature of the temperature retaining step is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

The temperature in the treatment chamber of the heat treatment apparatus preferably falls within the above range. Note that the temperature set for the heat treatment apparatus is not the same as the temperature in the treatment chamber in some cases. For example, the temperature in the treatment chamber is sometimes lower than the set temperature. The set temperature is adjusted such that the temperature in the treatment chamber falls within the above range. Note that in the case where the temperature in the treatment chamber cannot be measured, the temperature is set for the heat treatment apparatus to fall within the above range. In the case where the temperature of an object can be measured, it is further preferable that the temperature of the object fall within the above range.

After the temperature rising step, a phenomenon in which the temperature in the treatment chamber becomes higher than the set temperature (also referred to as overshoot) sometimes occurs at the beginning of the temperature retaining step. Also in the case where the overshoot occurs, the temperature rising rate is preferably adjusted such that the temperature in the treatment chamber falls within the above-described temperature range of the temperature retaining step. A plurality of temperature rising steps at different temperature rising rates may be provided. For example, a first temperature rising step and a second temperature rising step after the first temperature rising step are provided, and the temperature rising rate in the second temperature rising step is set lower than the temperature rising rate in the first temperature rising step. This can inhibit occurrence of the overshoot. Note that in the case where the temperature temporarily deviates from the temperature range of the temperature retaining step because of the overshoot, the deviation period is preferably short.

When the time of the temperature retaining step is too short, lithium cobalt oxide is sometimes not synthesized, but when the time of the temperature retaining step is too long, the productivity is lowered. For example, the time is preferably longer than or equal to 1 hour and shorter than or equal to 100 hours, further preferably longer than or equal to 2 hours and shorter than or equal to 20 hours.

Note that the temperature rising step, the temperature retaining step, and a cooling step do not need to be strictly distinguished from each other. In the heat treatment, the length of a period in which the temperature falls within the above-described temperature range is included in the above-described time range. Thus, in this specification and the like, the temperature of the temperature retaining step is sometimes referred to as a heat treatment temperature or a heating temperature, and the time of the temperature retaining step is sometimes referred to as a heat treatment time or a heating time.

The atmosphere of each of the temperature rising step and the temperature retaining step preferably contains fluoride gas and oxygen.

When the formation apparatus illustrated in FIG. 3A and FIG. 3B is used, a method may be employed in which an atmosphere in the heating furnace is replaced with a desired gas and then the gas is circulated so as not to enter and exit from the heating furnace. For example, the atmosphere in the heating furnace can be replaced with a gas containing oxygen and the gas can be circulated so as not to enter and exit from the treatment chamber. Alternatively, the gas may be introduced after the pressure in the treatment chamber is reduced. Specifically, the pressure in the treatment chamber is reduced to −970 hPa and then the gas is introduced until the pressure reaches 50 hPa, for example.

After the temperature retaining step, the object is cooled down in the cooling step. The time of the cooling step is longer than or equal to 15 minutes and shorter than or equal to 50 hours, for example. The cooling step may be performed by natural cooling. The temperature does not necessarily need to decrease to room temperature as long as it decreases to a temperature acceptable to the next step.

The heating zone in the formation apparatus illustrated in FIG. 3 can be divided into two regions (hereinafter, a first heating zone and a second heating zone). In the formation apparatus illustrated in FIG. 3, the heating unit 112b is set to a higher temperature than the heating unit 112a and the heating unit 112c to adjust the heating temperature. When a container is moved from a position close to the heating unit 112b to the heating unit 112c, the temperature decreases; thus, the heating unit 112c can also be referred to as a cooling device.

A heat-resistant container and a lid that are used for the heat treatment are preferably aluminum oxide or mullite cordierite. As aluminum oxide used for the heat-resistant container and the lid, a material containing almost no impurities is preferably used. In this embodiment, for example, aluminum oxide with a purity of 99.9% can be used. Heating is preferably performed with the heat-resistant container covered with the lid, in which case volatilization of a material can be prevented.

A heat-resistant container (a cylindrical container, a pod, a crucible, or a setter) and a lid that have been used a plurality of times are preferred to new ones. In this specification and the like, a new container refers to a container that is subjected to heating two or less times while a material containing lithium, a transition metal M included in the positive electrode active material 100, and/or an additive element is contained therein. A used container refers to a container that is subjected to heating three or more times while a material containing lithium, the transition metal M, and/or the additive element is contained therein. The reason is that, in the case where a new container is used, some materials such as lithium fluoride might be absorbed by, diffused in, transferred to, and/or attached to the container at the time of heating. Loss of some materials due to such phenomena increases a concern that an element is not distributed in a preferable range particularly in the surface portion of the positive electrode active material. By contrast, such a risk is low in the case of a used container.

After the heat treatment, the material that has been subjected to the heat treatment is ground as needed and may be made to pass through a sieve. Before collection of the material that has been subjected to the heat treatment, the material may be moved from the container to a mortar. As the mortar, a mortar made of zirconium oxide or agate can be suitably used. An aluminum oxide mortar can also be used. Note that heat treatment in a step other than Step S13 can be performed in a manner similar to that in Step S13.

### <Step S14>

Through the above steps, lithium cobalt oxide (LiCoO₂) can be obtained in Step S14.

Although the example is described here in which the composite oxide is formed by a solid phase method as in Step S11 to Step S14, the composite oxide may be formed by a coprecipitation method. Alternatively, the composite oxide may be formed by a hydrothermal method.

In Step S14, pre-synthesized lithium cobalt oxide can be prepared. Note that the composite oxide obtained or prepared in Step S14 sometimes contains an additive element in advance. To the composite oxide containing the additive element, for example, an additive element is further added through later-described steps (Step S20, Step S31 to Step S34, and the like), so that the positive electrode active material suitably containing the additive element in each of the surface portion and the inner portion can be formed.

Note that the formation process can be simplified by not performing the initial heating after Step S14.

Here, Table 1 to Table 3 show examples of analyzing the concentrations of elements in the lithium cobalt oxide by glow discharge mass spectrometry (GD-MS). Table 1 to Table 3 show four kinds of materials (a material Sm-1, a material Sm-2, a material Sm-3, and a material Sm-4). For easy viewing, one table is divided into Table 1 to Table 3. Note that the four kinds of materials (the material Sm-1, the material Sm-2, the material Sm-3, and the material Sm-4) shown in Table 1 can each be used as the lithium cobalt oxide in Step S14. In addition, “Matrix” in the table means a main component. The measurement value of each element obtained in ppm weight can be converted into atomic % by multiplying the measurement value by the atomic weight of each element and expressing the result in percentage.

TABLE 1
[ppm wt]

| Element | Sm-1 | Sm-2 | Sm-3 | Sm-4 |
|---|---|---|---|---|
| Mg | 30 | 25 | 44 | 800 |
| Ni | 18 | 7.4 | 140 | 0.42 |
| Al | 57 | 67 | 67 | 19 |
| Ti | 39 | ~3100 | 5.1 | 2.7 |
| Mn | 7.4 | 10 | 4.4 | 0.56 |
| F | 9.4 | 3.4 | 35 | 110 |
| P | 12 | 13 | 5.6 | 11 |
| Li | Matrix | Matrix | Matrix | Matrix |
| Co | Matrix | Matrix | Matrix | Matrix |
| O | Matrix | Matrix | Matrix | Matrix |
| Be | <0.01 | <0.01 | <0.01 | <0.01 |
| B | 2.5 | 4.3 | 1.5 | 6.6 |
| Na | 54 | 49 | 40 | 48 |
| Si | 94 | 44 | 80 | 37 |
| S | 67 | 520 | 340 | 580 |
| Cl | ~9.4 | ~6.7 | ~6.7 | 6.4 |

TABLE 2
[ppm wt]

| Element | Sm-1 | Sm-2 | Sm-3 | Sm-4 |
|---|---|---|---|---|
| K | 3.7 | 3.8 | 3.8 | 1 |
| Ca | 26 | 250 | 87 | 280 |
| Sc | <0.01 | 0.02 | 0.03 | <0.01 |
| V | 0.02 | 0.02 | 0.05 | 0.04 |
| Cr | 4.7 | 8 | 8 | 1.1 |
| Fe | 14 | 19 | 48 | 2.8 |
| Cu | 0.45 | 0.94 | 6.4 | 0.11 |
| Zn | 1.2 | <0.5 | 0.87 | <0.5 |
| Ga | <0.1 | <0.1 | <0.1 | <0.1 |
| Ge | <0.5 | <0.5 | <0.5 | <0.5 |
| As | ≤32 | ≤740 | ≤1100 | ≤60 |
| Se | <0.5 | <0.5 | <0.5 | <0.5 |
| Br | <0.1 | <0.1 | <0.1 | <0.1 |
| Rb | <0.05 | <0.05 | <0.05 | <0.05 |
| Sr | 3.4 | 31 | 8 | 2.3 |
| Y | <0.05 | 1.5 | <0.05 | <0.05 |
| Zr | 0.51 | 4 | 7.4 | 1.8 |
| Nb | <2 | <2 | <2 | <2 |
| Mo | <1 | <1 | 4.4 | <1 |
| Ru | <0.1 | <0.1 | <0.1 | <0.1 |
| Rh | <0.05 | <0.05 | <0.05 | <0.05 |
| Pd | <0.1 | <0.1 | <0.1 | <0.1 |
| Ag | <0.5 | <0.5 | <0.5 | <0.5 |
| Cd | <0.5 | <0.5 | <0.5 | <0.5 |
| In | Binder | Binder | Binder | Binder |
| Sn | <0.5 | 0.8 | 1 | <0.5 |
| Sb | 5.6 | 3.5 | 4.7 | 1.1 |
| Te | <0.05 | <0.05 | <0.05 | <0.05 |
| I | ≤140 | ≤94 | ≤110 | ≤57 |

TABLE 3
[ppm wt]

| Element | Sm-1 | Sm-2 | Sm-3 | Sm-4 |
|---|---|---|---|---|
| Cs | <0.05 | <0.05 | <0.05 | <0.05 |
| Ba | ≤1.3 | ≤19 | ≤25 | ≤1.0 |
| La | 0.48 | 0.74 | 0.41 | 0.87 |
| Ce | <0.1 | 0.48 | 0.67 | <0.1 |
| Pr | <0.1 | <0.1 | 0.27 | 0.38 |
| Nd | <0.1 | <0.1 | <0.1 | <0.1 |
| Sm | <0.1 | <0.1 | <0.1 | <0.1 |
| Eu | <0.1 | <0.1 | <0.1 | <0.1 |
| Gd | <0.1 | <0.1 | <0.1 | <0.1 |
| Tb | <0.1 | <0.1 | <0.1 | <0.1 |
| Dy | <0.1 | <0.1 | <0.1 | <0.1 |
| Ho | <0.1 | <0.1 | <0.1 | <0.1 |
| Er | <0.1 | <0.1 | <0.1 | <0.1 |
| Tm | <0.1 | <0.1 | <0.1 | <0.1 |
| Yb | <0.1 | <0.1 | <0.1 | <0.1 |
| Lu | <0.1 | <0.1 | <0.1 | <0.1 |
| Hf | <0.5 | <0.5 | <0.5 | <0.5 |
| Ta | Source | Source | Source | Source |
| W | <1 | 1.3 | 1.3 | <1 |
| Re | <0.5 | <0.5 | <0.5 | <0.5 |
| Os | <0.1 | <0.1 | <0.1 | <0.1 |
| Ir | <0.1 | <0.1 | <0.1 | <0.1 |
| Pt | <0.5 | <0.5 | <0.5 | <0.5 |
| Au | <10 | <10 | <10 | <10 |
| Hg | <0.5 | <0.5 | <0.5 | <0.5 |
| Tl | <0.05 | <0.05 | <0.05 | <0.05 |
| Pb | <0.05 | <0.05 | 4.5 | 0.09 |
| Bi | <0.05 | <0.05 | <0.05 | 0.19 |
| Th | <0.01 | 0.02 | <0.01 | <0.01 |
| U | <0.01 | <0.01 | <0.01 | <0.01 |

### <Step S20>

Next, preparation of an additive element A source (A source) shown in Step S20 is described with reference to FIG. 4A, FIG. 4B, and FIG. 5.

First, Step S20 (Step S21 to Step S23 described in FIG. 4B in detail) shown in FIG. 4A is described.

### <Step S21>

In Step S21 shown in FIG. 4B, the additive element A source (A source) to be added to the lithium cobalt oxide is prepared. A lithium source may be prepared together with the additive element A source.

As the additive element A, the above-described additive element can be used. Specifically, one or more selected from magnesium, fluorine, nickel, aluminum, titanium, zirconium, vanadium, iron, manganese, chromium, niobium, arsenic, zinc, silicon, sulfur, phosphorus, boron, bromine, and beryllium can be used as the additive element A.

In the case where magnesium is used as the additive element, the additive element source can be referred to as a magnesium source. As the magnesium source, for example, magnesium fluoride, magnesium oxide, magnesium hydroxide, or magnesium carbonate can be used. Note that a plurality of kinds of magnesium sources may be used.

In the case where fluorine is used as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in heat treatment owing to its relatively low melting point of 848° C. Note that a plurality of kinds of fluorine sources may be used.

Magnesium fluoride can be used as both the fluorine source and the magnesium source. Lithium fluoride can also be used as the lithium source.

The fluorine source may be a gas. In the case of using a gas-state fluorine source, the fluorine source is mixed into an atmosphere in later heat treatment, and the heat treatment is performed while the material to be heated is stirred using the heat treatment apparatus illustrated in FIG. 1 or FIG. 3. As the gas-state fluorine source, for example, fluorine (F₂), carbon fluoride, a nitrogen fluoride (NF₃) gas, sulfur fluoride, or oxygen fluoride (OF₂, O₂F₂, O₃F₂, O₄F₂, O₅F₂, O₆F₂, or O₂F) can be used. Note that a plurality of kinds of fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or the neighborhood thereof). Note that in this specification and the like, the neighborhood means a value greater than 0.9 times and less than 1.1 times a given value.

### <Step S22>

Next, in Step S22 shown in FIG. 5, the magnesium source and the fluorine source prepared in Step S21 are ground and mixed. The detailed description of this step is omitted because the description of Step S12 can be referred to.

### <Step S23>

Next, in Step S23 shown in FIG. 4B, the materials ground and mixed in Step S22 are collected to give the additive element A source (A source). Note that the additive element A source in Step S23 contains a plurality of materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may contain one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion of the composite oxide after heating.

Next, Step S21 (Step S21 to Step S23) shown in FIG. 5 is described.

### <Step S21>

In Step S21 shown in FIG. 5, four kinds of additive element sources to be added to the lithium cobalt oxide are prepared. In other words, FIG. 5 is different from FIG. 4B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. The magnesium source and the fluorine source can be selected from the compounds and the like described with reference to FIG. 5. As the nickel source, nickel oxide or nickel hydroxide can be used. Note that a plurality of kinds of nickel sources may be used. As the aluminum source, aluminum oxide or aluminum hydroxide can be used. Note that a plurality of kinds of aluminum sources may be used.

Although the example in which the four kinds of additive elements (Mg, F, Ni, and Al) are used is described here, one embodiment of the present invention is not limited thereto. There is no particular limitation on the number of kinds of the additive elements.

### <Step S22 and Step S23>

Step S22 and Step S23 shown in FIG. 5 are similar to Step S22 and Step S23 described with reference to FIG. 4B. Thus, the additive element A source (A source) containing the four kinds of additive elements (Mg, F, Ni, and Al) can be obtained.

### <Step S31>

Next, in Step S31 shown in FIG. 4A, the lithium cobalt oxide and the additive element A source (A source) are mixed. The atomic ratio of cobalt Co in the lithium cobalt oxide to magnesium Mg contained in the additive element A source is preferably Co:Mg=100:y (0.1≤y≤6), further preferably M:Mg=100:y (0.3≤y≤3).

The conditions of the mixing in Step S31 are preferably milder than those of the mixing in Step S12 in order not to damage the shapes of the lithium cobalt oxide particles. For example, conditions with a lower rotational frequency or a shorter time than those for the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C., for example. When the mixing is performed in the dry room, attachment of moisture to the lithium cobalt oxide and the additive element A source (A source) can be inhibited.

### <Step S32>

Next, in Step S32 in FIG. 4A, the materials mixed in the above step are collected, whereby a mixture 903 is obtained. At the time of the collection, the materials may be crushed as needed and made to pass through a sieve.

### <Step S33>

Next, in Step S33 shown in FIG. 4A, the mixture 903 is subjected to heat treatment. For the heat treatment, the description of Step S13 can be referred to. For the heat treatment, the heat treatment apparatus illustrated in FIG. 1 or FIG. 3 can be used.

The heating time is preferably longer than or equal to 2 hours. Here, the pressure in the treatment chamber may be higher than atmospheric pressure to increase the oxygen partial pressure in the treatment chamber of the heat treatment apparatus illustrated in FIG. 1 or FIG. 3. A low oxygen partial pressure in the treatment chamber might cause reduction of cobalt or the like and hinder the lithium cobalt oxide or the like from maintaining a layered rock-salt crystal structure.

Here, a supplementary explanation of the heating temperature is given. The heating temperature in Step S33 needs to be higher than or equal to the temperature at which a reaction between the lithium cobalt oxide and the additive element source proceeds. The temperature at which the reaction proceeds is the temperature at which interdiffusion of the elements contained in the lithium cobalt oxide and the additive element source occurs, and may be lower than the melting temperatures of these materials. In the case of an oxide, the temperature at which solid phase diffusion occurs (Tamman temperature T_{d}) is 0.757 times the melting temperature Tₘ. Accordingly, the heating temperature in Step S33 is higher than or equal to 650° C.

Needless to say, the reaction more easily proceeds at a temperature higher than or equal to the temperature at which one or more of the materials contained in the mixture 903 are melted. For example, in the case where LiF and MgF₂ are included as the additive element sources, the lower limit of the heating temperature in Step S33 is preferably higher than or equal to 742° C. because the eutectic point of LiF and MgF₂ is around 742° C.

The mixture 903 obtained by mixing at LiCoO₂:LiF:MgF₂=100:0.33:1 (molar ratio) exhibits an endothermic peak at around 830° C. in differential scanning calorimetry measurement (DSC). Therefore, the lower limit of the heating temperature is further preferably higher than or equal to 830° C.

A higher heating temperature is preferable because it facilitates the reaction, can shorten the heating time, and enables high productivity.

The heating temperature is lower than the decomposition temperature of the lithium cobalt oxide (1130° C.). At around the decomposition temperature, a slight amount of lithium cobalt oxide might be decomposed. Thus, the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

A temperature rising rate is preferably higher than or equal to 80° C./h and lower than or equal to 250° C./h, although depending on the end-point temperature. In the case where the temperature of the temperature retaining step is 1000° C., for example, the temperature rising rate is preferably 200° C./h.

In addition, at the time of heat treatment on the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having excellent characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. In addition, with the use of the heat treatment apparatus illustrated in FIG. 1 or FIG. 3, the mixture 903 is preferably heated while the fluoride gas and the oxygen gas are circulated. Such heating can inhibit volatilization of LiF in the mixture 903.

The heat treatment in Step S33 is preferably performed such that particles of the mixture 903 are heated while being stirred so as not to adhere to one another. When the mixture is put in a container such as a crucible and heated without being stirred, the particles of the mixture adhere to one another; thus, the mixture needs to be raked out and large particles formed by adhesion need to be crushed in a later step. With the use of the heat treatment apparatus illustrated in FIG. 1 or FIG. 3, heating is performed with stirring, whereby the particles do not adhere to the container; thus, a later crushing step can be unnecessary and the productivity is improved.

In the case where the lithium cobalt oxide obtained in Step S14 in FIG. 4A has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example.

In the case where the lithium cobalt oxide obtained in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example.

The positive electrode active material of one embodiment of the present invention can be formed by a formation method in which heating is performed in an atmosphere in which a fluoride gas is contained and circulated.

With the use of the method for forming the positive electrode active material of one embodiment of the present invention, the additive element such as magnesium can be distributed in a thin region of the surface portion in the concentration distribution of the additive element in the depth direction.

In the method for forming the positive electrode active material of one embodiment of the present invention, the effect of the fusing agent enables the positive electrode active material to have a smooth surface with little unevenness. It is considered that the positive electrode active material having a smooth surface is durable and hardly cracked even when the temperature decreasing rate is increased.

Note that the material that has been subjected to the heat treatment in Step S33 is sometimes denoted with an ordinal number to be distinguished from the composite oxide in Step S14. For example, in some cases, the composite oxide in Step S14 is referred to as a first composite oxide, and the material that has been subjected to the heat treatment in Step S33 is referred to as a second composite oxide.

### <Step S34>

Next, in Step S34 shown in FIG. 4A, the material that has been subjected to the heat treatment is collected and then crushed as needed to obtain the positive electrode active material 100. Here, the collected particles are preferably made to pass through a sieve. Through the above process, the positive electrode active material 100 of one embodiment of the present invention can be formed. The positive electrode active material of one embodiment of the present invention has a smooth surface.

The positive electrode active material 100 with a smooth surface may be less likely to be physically broken by pressure application or the like than a positive electrode active material without a smooth surface. For example, the positive electrode active material 100 is unlikely to be broken in a test involving pressure application such as a nail penetration test, meaning that the positive electrode active material 100 has high safety.

Although the formation method in which the additive element is added after the lithium cobalt oxide is obtained is described here, one embodiment of the present invention is not limited thereto. The addition of the additive element may be performed at another timing or may be performed a plurality of times. The timing of the addition may be different between the additive elements.

For example, the additive element source may be added to the lithium source and the cobalt source in Step S11, i.e., at the stage of the starting materials of the composite oxide. Then, lithium cobalt oxide containing the additive element can be obtained in Step S13. In that case, there is no need to separately perform Step S11 to Step S14 and Step S21 to Step S23. This method can be regarded as being simple and highly productive.

Lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

### <<Example 2 of Method for Forming Positive Electrode Active Material>>

A method for forming the positive electrode active material, which is different from that described above in Example 1 of method for forming positive electrode active material, is described with reference to FIG. 6.

An example of the method for forming the positive electrode active material described here is different from Example 1 of method for forming positive electrode active material described above mainly in that heat treatment (i.e., initial heating) is performed after the lithium cobalt oxide (LiCoO₂) is obtained in Step S14 but before the additive element A source (A source) is mixed in Step S31. When the additive element A is added to the lithium cobalt oxide that has been subjected to the initial heating, the additive element A can be uniformly added. It is thus preferable that the initial heating precede the addition of the additive element A. For the process other than the initial heating, the above description of Example 1 of method for forming positive electrode active material can be referred to.

First, as in FIG. 4A, lithium cobalt oxide is obtained through Step S11 to Step S14.

### <Step S15>

Next, in Step S15 shown in FIG. 6, the lithium cobalt oxide is subjected to heat treatment. The heat treatment in Step S15 is the first heat treatment performed on the lithium cobalt oxide and thus can be referred to as initial heating. Alternatively, the heat treatment in Step S15 is performed before Step S20 and thus is sometimes referred to as preheating treatment or pretreatment.

By the initial heating, lithium is extracted from part of the surface portion of the lithium cobalt oxide as described above. In addition, an effect of increasing the crystallinity of the inner portion of the lithium cobalt oxide can be expected. The lithium source and/or the cobalt source prepared in Step S11 and the like might contain impurities. The initial heating can reduce impurities in the lithium cobalt oxide obtained in Step S14.

The initial heating can sometimes shorten the time of heat treatment performed later (e.g., the time of heat treatment in Step S33). Furthermore, in the method for forming the positive electrode active material of one embodiment of the present invention, the time of the cooling step can be shortened. Accordingly, the time of the heat treatment in the whole formation process of the positive electrode active material 100 can be shortened, thereby improving the productivity.

Through the initial heating, an effect of smoothing the surface of the lithium cobalt oxide is obtained. The lithium cobalt oxide having a smooth surface refers to the composite oxide having little unevenness and rounded as a whole with its corner portion rounded. A smooth surface also refers to a surface to which few foreign matters are attached. Foreign matters are deemed to cause projections and depressions and are preferably not attached to a surface.

For the initial heating, there is no need to prepare the lithium source. Alternatively, there is no need to prepare the additive element source. Alternatively, there is no need to prepare a material functioning as a fusing agent.

When the time of the initial heating is too short, a sufficient effect is not obtained, but when the time of the initial heating is too long, the productivity is lowered. For the initial heating, for example, the description of Step S13 can be referred to. Specifically, the temperature of the initial heating is preferably lower than the heating temperature in Step S13 so that the crystal structure of the composite oxide is maintained. The time of the initial heating is preferably shorter than the heating time in Step S13 so that the crystal structure of the composite oxide is maintained. For example, the initial heating is performed at higher than or equal to 700° C. and lower than or equal to 1000° C. for longer than or equal to 2 hours and shorter than or equal to 20 hours.

The effect of increasing the crystallinity of the inner portion of the lithium cobalt oxide is, for example, an effect of reducing distortion, a shift, or the like derived from differential shrinkage or the like of the lithium cobalt oxide that is caused by the heat treatment in Step S13.

The heat treatment in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth. This is also rephrased as alignment of crystal grains. In other words, it is deemed that Step S15 reduces the shift in a crystal or the like which is caused in the composite oxide to make the surface of the composite oxide smooth.

In a secondary battery including lithium cobalt oxide with a smooth surface as a positive electrode active material, degradation by charging and discharging is inhibited and a crack in the positive electrode active material can be prevented.

Note that pre-synthesized lithium cobalt oxide may be used in Step S14. In that case, Step S11 to Step S13 can be skipped. When Step S15 is performed on the pre-synthesized lithium cobalt oxide, lithium cobalt oxide with a smooth surface can be obtained.

After that, Step S20 to Step S33 are performed as in FIG. 4A, FIG. 4B, and FIG. 5.

Note that the composite oxide in Step S14, the material that has been subjected to the heat treatment in Step S15, and the material that has been subjected to the heat treatment in Step S33 are sometimes denoted with ordinal numbers to be distinguished from one another. For example, in some cases, the composite oxide in Step S14 is referred to as a first composite oxide, the material that has been subjected to the heat treatment in Step S15 is referred to as a second composite oxide, and the material that has been subjected to the heat treatment in Step S33 is referred to as a third composite oxide.

### <Step S34>

Next, in Step S34, the material that has been subjected to the heat treatment is collected and then crushed as needed to obtain the positive electrode active material 100. Here, the collected particles are preferably made to pass through a sieve. Through the above process, the positive electrode active material 100 of one embodiment of the present invention can be formed. The positive electrode active material of one embodiment of the present invention has a smooth surface.

The initial heating in Step S15 in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. The steps are preferably performed in such an order to maintain the smoothness of the surface achieved by the initial heating.

This embodiment can be used in combination with the other embodiments.

### Embodiment 3

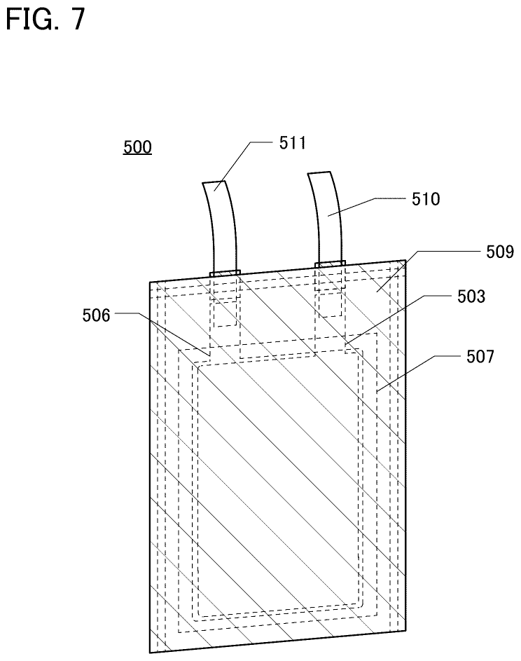

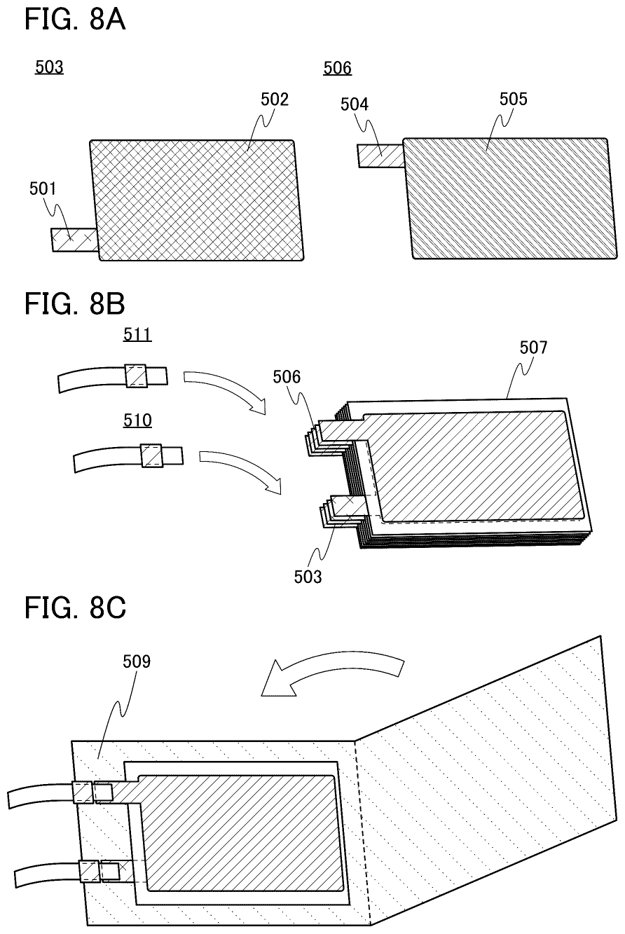

FIG. 7 and FIG. 8 illustrate an example of an external view of a laminated secondary battery 500. In FIG. 7 and FIG. 8, a positive electrode 503, a negative electrode 506, a separator 507, an exterior body 509, a positive electrode lead electrode 510, and a negative electrode lead electrode 511 are included. When the laminated secondary battery has flexibility and is used in an electronic device at least part of which is flexible, the secondary battery can be bent as the electronic device is bent. An example of a method for fabricating the laminated secondary battery will be described with reference to FIG. 8A to FIG. 8C.

First, the negative electrode 506, the separator 507, and the positive electrode 503 are stacked. FIG. 8B illustrates the negative electrode 506, the separator 507, and the positive electrode 503 that are stacked. Here, an example in which five negative electrodes and four positive electrodes are used is illustrated. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion indicated by a dashed line as illustrated in FIG. 8C. Then, the outer edges of the exterior body 509 are bonded to each other. The bonding is performed by thermocompression, for example. At this time, an unbonded region (hereinafter, referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert gas atmosphere. Lastly, the inlet is sealed by bonding. In this manner, the laminated secondary battery 500 can be fabricated.

When the method for forming the positive electrode active material 100 described in the above embodiment is used for the positive electrode 503, the secondary battery 500 with high discharge capacity and excellent cycle performance can be obtained.

### <Structure Example 2 of Secondary Battery>

### [Solid Electrolyte]

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer are/is not necessary. Furthermore, the battery can be entirely solidified; therefore, there is no possibility of liquid leakage and thus the safety of the battery is dramatically improved.

A structure of a secondary battery including a solid electrolyte layer is described below as a structure example of a secondary battery.

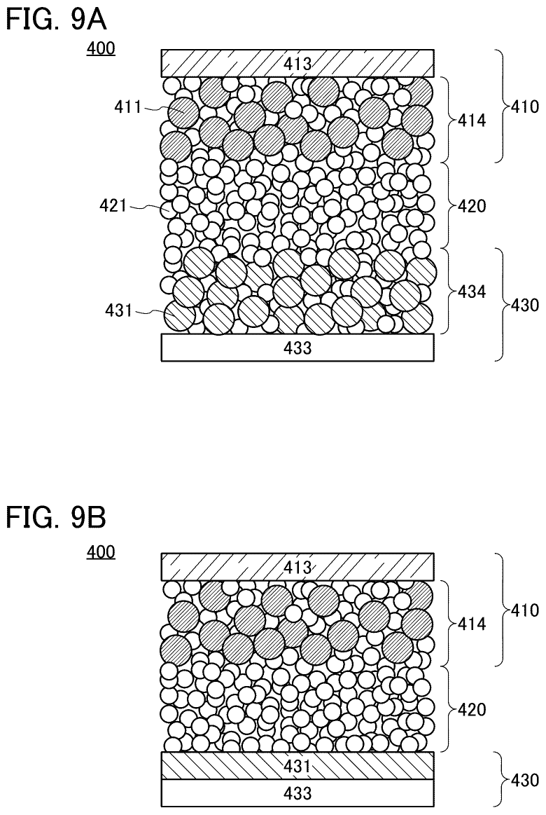

As illustrated in FIG. 9A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiment is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used for the negative electrode 430, the negative electrode 430 that does not include the solid electrolyte 421 can be formed, as illustrated in FIG. 9B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1+X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄) 3 and Li_{1.5}Al_{0.5}Ge_{1.5}(PO₄)₃). The oxide-based solid electrolyte has an advantage of stability in the air.

Examples of the halide-based solid electrolyte include LiAlCl₄, LisInBr₆, LiF, LiCl, LiBr, and LiI. Moreover, a composite material in which pores of porous aluminum oxide and/or porous silica are filled with such a halide-based solid electrolyte can be used as the solid electrolyte.

Note that different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of fabrication steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share corners are arranged three-dimensionally.

This embodiment can be used in appropriate combination with any of the other embodiments.

### Embodiment 4

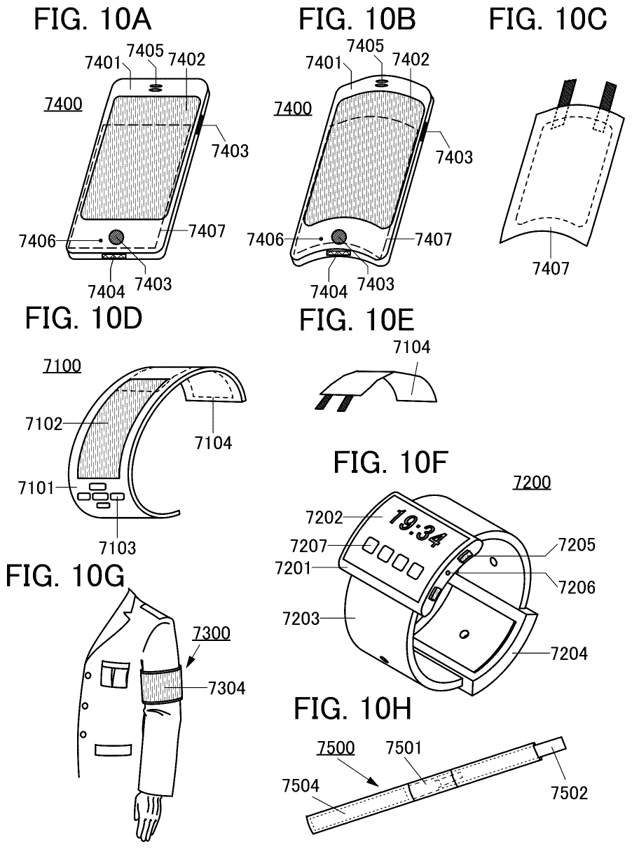

In this embodiment, examples of electronic devices each including the secondary battery of one embodiment of the present invention will be described with reference to FIG. 10A to FIG. 12C.

FIG. 10A to FIG. 10G illustrate examples of electronic devices each including the secondary battery containing the positive electrode active material described in the above embodiment. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

A flexible secondary battery can be incorporated along a curved inside or outside wall surface of a house, a building, or the like or a curved interior or exterior surface of an automobile.

FIG. 10A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight long-life mobile phone can be provided.

FIG. 10B illustrates the state where the mobile phone 7400 is bent. When the whole mobile phone 7400 is bent by the external force, the secondary battery 7407 included in the mobile phone 7400 is also bent. FIG. 10C illustrates the bent secondary battery 7407. The secondary battery 7407 is a thin storage battery. The secondary battery 7407 is fixed in a state of being bent. Note that the secondary battery 7407 includes a lead electrode electrically connected to a current collector.

FIG. 10D illustrates an example of a bangle display device. A portable display device 7100 includes a housing 7101, a display portion 7102, operation buttons 7103, and a secondary battery 7104. FIG. 10E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the positive electrode active material of one embodiment of the present invention is used for the secondary battery 7104, a portable display device with a long-life secondary battery can be provided.

FIG. 10F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication with a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the positive electrode active material of one embodiment of the present invention is used for the secondary battery, a portable information terminal with a lightweight long-life secondary battery can be provided. For example, the secondary battery 7104 illustrated in FIG. 10E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 10G illustrates an example of an armband display device. A display device 7300 includes a display portion 7304 and the secondary battery using the positive electrode active material of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charging via the input/output terminal is possible. Note that the charging operation may be performed by wireless power feeding without using the input/output terminal.

When the secondary battery including the positive electrode active material of one embodiment of the present invention is used as the secondary battery included in the display device 7300, a display device with a lightweight long-life secondary battery can be provided.

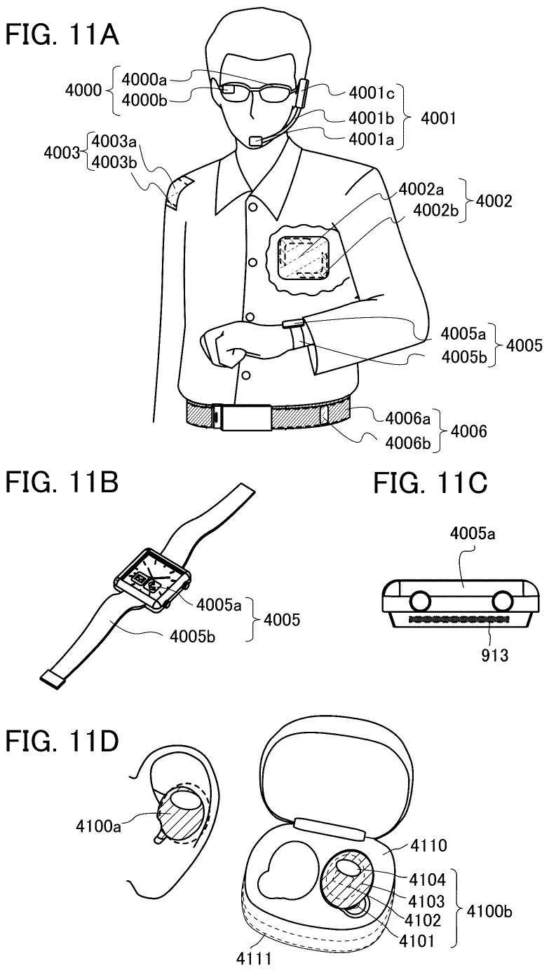

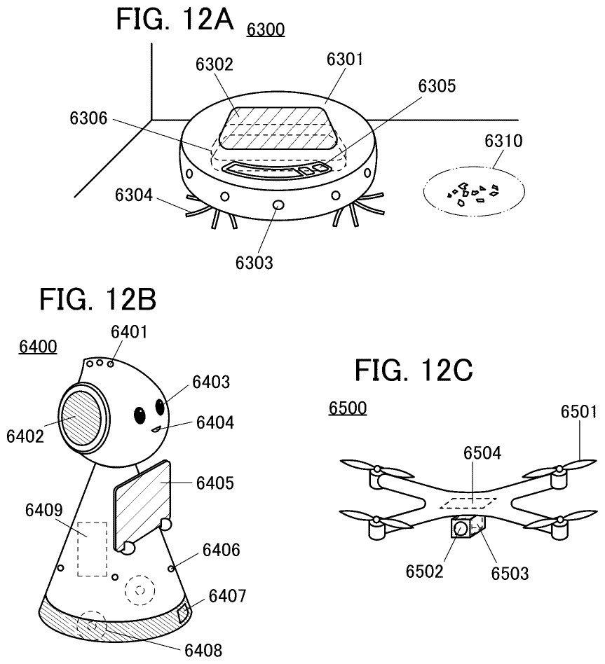

Examples of electronic devices each including the secondary battery with favorable cycle performance described in the above embodiment are described with reference to FIG. 10H, FIG. 11, and FIG. 12.

When the secondary battery of one embodiment of the present invention is used as a secondary battery of a daily electronic device, a lightweight long-life product can be provided. Examples of the daily electronic device include an electric toothbrush, an electric shaver, and electric beauty equipment. As secondary batteries of these products, small and lightweight stick type secondary batteries with high discharge capacity are desired in consideration of handling ease for users.

FIG. 10H is a perspective view of a device called a cigarette smoking device (electronic cigarette). In FIG. 10H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharging and/or overdischarging of the secondary battery 7504 may be electrically connected to the secondary battery 7504. The secondary battery 7504 illustrated in FIG. 10H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and favorable cycle performance, the small and lightweight electronic cigarette 7500 that can be used for a long time over a long period can be provided.

FIG. 11A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 11A. The glasses-type device 4000 includes a frame 4000a and a display portion 4000b. When the positive electrode active material of one embodiment of the present invention is used for the secondary battery, high discharge capacity and favorable cycle performance can be achieved. The secondary battery is provided in a temple portion of the frame 4000a having a curved shape, whereby the glasses-type device 4000 can be lightweight, can have a well-balanced weight, and can be used continuously for a long time.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. When the positive electrode active material of one embodiment of the present invention is used for the secondary battery, high discharge capacity and favorable cycle performance can be achieved.

The secondary battery of one embodiment of the present invention can be provided in a device 4002 that can be attached directly to a body. A secondary battery 4002b can be provided in a thin housing 4002a of the device 4002. When the positive electrode active material of one embodiment of the present invention is used for the secondary battery, high discharge capacity and favorable cycle performance can be achieved.

The secondary battery of one embodiment of the present invention can be provided in a device 4003 that can be attached to clothes. A secondary battery 4003b can be provided in a thin housing 4003a of the device 4003. When the positive electrode active material of one embodiment of the present invention is used for the secondary battery, high discharge capacity and favorable cycle performance can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. When the positive electrode active material of one embodiment of the present invention is used for the secondary battery, high discharge capacity and favorable cycle performance can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. When the positive electrode active material of one embodiment of the present invention is used for the secondary battery, high discharge capacity and favorable cycle performance can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 11B is a perspective view of the watch-type device 4005 that is detached from an arm.

FIG. 11C is a side view. FIG. 11C illustrates a state where a secondary battery 913 is incorporated inside. The secondary battery 913, which is small and lightweight, is provided at a position overlapping with the display portion 4005a.

FIG. 11D illustrates an example of wireless earphones. The wireless earphones illustrated here consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery, the cylindrical secondary battery, or the like of the above embodiment can be used. A secondary battery whose positive electrode includes the positive electrode active material 100 obtained by the formation method in Embodiment 1 has high discharge capacity and favorable cycle performance; thus, with the use of the secondary battery as each of the secondary battery 4103 and the secondary battery 4111, the sizes of these secondary batteries can be reduced. This enables the wireless earphones to have a small size, for example.

FIG. 12A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes a secondary battery 6306 of one embodiment of the present invention and a semiconductor device or an electronic component. When the secondary battery 6306 including the positive electrode active material of one embodiment of the present invention is used for the cleaning robot 6300, the cleaning robot 6300 can operate for a long time and be highly reliable.

FIG. 12B illustrates an example of a robot. A robot 6400 illustrated in FIG. 12B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. When the secondary battery including the positive electrode active material of one embodiment of the present invention is used for the robot 6400, the robot 6400 can operate for a long time and be highly reliable.

FIG. 12C illustrates an example of a flying object. A flying object 6500 illustrated in FIG. 12C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 including the positive electrode active material of one embodiment of the present invention. When the secondary battery of one embodiment of the present invention is used for the flying object 6500, the flying object 6500 can operate for a long time and be highly reliable.

This embodiment can be implemented in appropriate combination with any of the other embodiments.

### Embodiment 5

In this embodiment, examples of vehicles each including the secondary battery containing the positive electrode active material of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

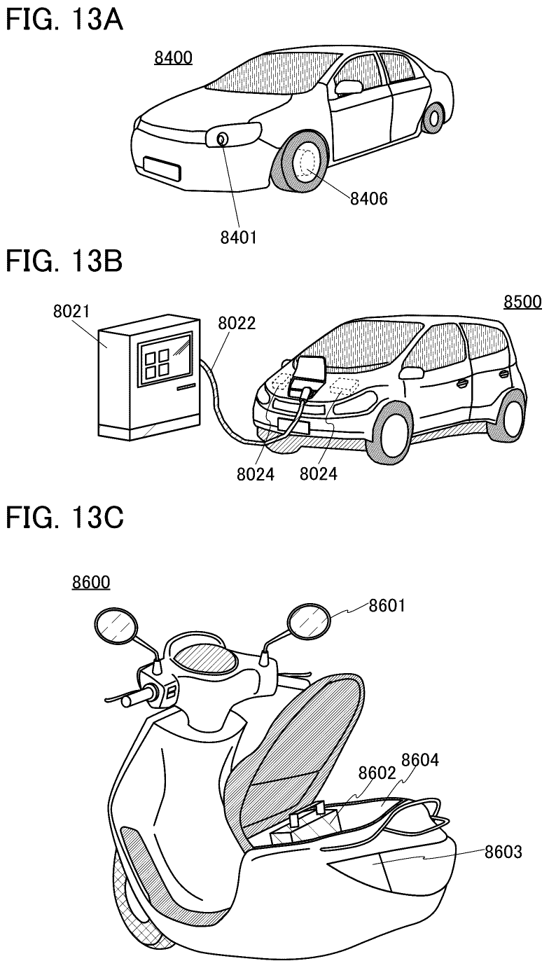

FIG. 13A illustrates an example of a vehicle using the secondary battery including the positive electrode active material of one embodiment of the present invention. An automobile 8400 illustrated in FIG. 13A is an electric vehicle using an electric motor as a power source. Alternatively, the automobile 8400 is a hybrid electric vehicle capable of appropriately selecting and using an electric motor or an engine as a power source. The use of the secondary battery including the positive electrode active material of one embodiment of the present invention enables a high-mileage vehicle. The automobile 8400 includes the secondary battery. For example, the modules of the secondary battery can be arranged in a floor portion in the automobile to be used. The secondary battery can be used not only for driving an electric motor 8406, but also for supplying power to a light-emitting device such as a headlight 8401 and a room light (not illustrated).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 13B can be charged when the secondary battery included in the automobile 8500 is supplied with power through external charge equipment by a plug-in system, a contactless power feeding system, and/or the like. FIG. 13B illustrates a state where a secondary battery 8024 included in the automobile 8500 is charged with the use of a ground-based charging apparatus 8021 through a cable 8022. In charging, a given method such as CHAdeMO (registered trademark) or Combined Charging System may be employed as a charging method, the standard of a connector, and the like as appropriate. The charging apparatus 8021 may be a charging station provided in a commerce facility or a power source at home. For example, with the use of a plug-in technique, the secondary battery 8024 provided in the automobile 8500 can be charged by being supplied with power from the outside. Charging can be performed by converting AC power into DC power through a converter such as an ACDC converter.

Although not illustrated, the vehicle may include a power receiving device so that it can be charged by being supplied with power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of power between vehicles. Furthermore, a solar cell may be provided in the exterior of the vehicle to charge the secondary battery when the vehicle stops and/or moves. To supply power in such a contactless manner, an electromagnetic induction method and/or a magnetic resonance method can be used.

FIG. 13C is an example of a motorcycle using the secondary battery of one embodiment of the present invention. A motor scooter 8600 illustrated in FIG. 13C includes a secondary battery 8602, side mirrors 8601, and direction indicators 8603. The secondary battery 8602 can supply electricity to the direction indicators 8603.

In the motor scooter 8600 illustrated in FIG. 13C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

The use of the secondary battery including the positive electrode active material of one embodiment of the present invention leads to high discharge capacity and favorable cycle performance of the secondary battery, which allows the secondary battery to have high discharge capacity. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying power to products other than the vehicle. In such a case, the use of a commercial power supply can be avoided at peak time of power demand, for example. Avoiding the use of a commercial power supply at peak time of power demand can contribute to energy saving and a reduction in carbon dioxide emissions. Moreover, the secondary battery with favorable cycle performance can be used over a long period; thus, the amount of use of rare metals such as cobalt can be reduced.

This embodiment can be implemented in appropriate combination with any of the other embodiments.

### REFERENCE NUMERALS

110: rotary kiln, 110a: rotary kiln, 111: kiln main body, 112a: heating unit, 112b: heating unit, 112c: heating unit, 112: heating unit, 113: source material supply unit, 114: material collection unit, 115: supply pipe, 116a: gas supply unit, 116b: gas exhaust unit, 117: rotation driving device, 118: blade, 119: object, 120a: main body portion, 120b: lid portion, 120: heat-resistant container, 121: load chamber, 122: shutter, 123: shutter, 124: unload chamber, 160: heat-resistant container, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 500: secondary battery, 503: positive electrode, 506: negative electrode, 507: separator, 509: exterior body, 510: positive electrode lead electrode, 511: negative electrode lead electrode, 903: mixture, 913: secondary battery, 4000a: frame, 4000b: display portion, 4000: glasses-type device, 4001a: microphone portion, 4001b: flexible pipe, 4001c: earphone portion, 4001: headset-type device, 4002a: housing, 4002b: secondary battery, 4002: device, 4003a: housing, 4003b: secondary battery, 4003: device, 4005a: display portion, 4005b: belt portion, 4005: watch-type device, 4006a: belt portion, 4006b: wireless power feeding and receiving portion, 4006: belt-type device, 4100a: main body, 4100b: main body, 4101: driver unit, 4102: antenna, 4103: secondary battery, 4104: display portion, 4110: case, 4111: secondary battery, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 6500: flying object, 6501: propeller, 6502: camera, 6503: secondary battery, 6504: electronic component, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8021: charging apparatus, 8022: cable, 8024: secondary battery, 8400: automobile, 8401: headlight, 8406: electric motor, 8500: automobile, 8600: motor scooter, 8601: side mirror, 8602: secondary battery, 8603: direction indicator, 8604: under-seat storage

1. A method for forming a positive electrode active material comprising a crystal comprising lithium, a transition metal, and oxygen, the method comprising:
performing heat treatment while stirring a material to be heated in an atmosphere where a gas comprising fluorine and oxygen is circulated,
wherein crystallinity of the crystal in the material to be heated is improved by the heat treatment.

2. The method for forming a positive electrode active material, according to claim 1,
wherein the material to be heated is an oxide comprising lithium, and
wherein a temperature of the heat treatment is higher than or equal to 800° C. and lower than or equal to 1100° C.

3. The method for forming a positive electrode active material, according to claim 1,
wherein the heat treatment is performed in a state where the material to be heated is contained in a cylindrical heat-resistant container with a lid.

4. The method for forming a positive electrode active material, according to claim 1,
wherein the transition metal is one or two or more selected from cobalt, nickel, and manganese.

5. A formation apparatus comprising:
a heating furnace comprising a sealed atmosphere;
a heat-resistant container that is placed in the atmosphere, stores a material to be heated inside, and stirs the material to be heated during heating;
a supply unit supplying a gas comprising a fluoride gas and an oxygen gas to the heating furnace;
an exhaust unit exhausting the gas in the heating furnace; and
a supply pipe supplying the gas exhausted from the exhaust unit to the heating furnace from the supply unit again.

6. The formation apparatus according to claim 5,
wherein the heat-resistant container is a cylindrical heat-resistant container with a lid.

7. The formation apparatus according to claim 5,
wherein the heating furnace is a rotating drum.

8. The formation apparatus according to claim 5,
wherein the heating furnace comprises a furnace tube, and
wherein the furnace tube is cylindrical and rotates with a plurality of the heat-resistant containers put therein.

9. A method for forming a positive electrode active material comprising a crystal comprising lithium, a transition metal, and oxygen, the method comprising:
performing heat treatment while stirring a material to be heated in an atmosphere where a gas comprising fluorine and oxygen is flowed,
wherein crystallinity of the crystal in the material to be heated is improved by the heat treatment.

10. The method for forming a positive electrode active material, according to claim 9,
wherein the material to be heated is an oxide comprising lithium, and
wherein a temperature of the heat treatment is higher than or equal to 800° C. and lower than or equal to 1100° C.

11. The method for forming a positive electrode active material, according to claim 9,
wherein the heat treatment is performed in a state where the material to be heated is contained in a cylindrical heat-resistant container with a lid.

12. The method for forming a positive electrode active material, according to claim 9,
wherein the transition metal is one or two or more selected from cobalt, nickel, and manganese.
